(19) United States
(12) Patent Application Publication
(10) Pub. No.: US 2003/0229612 A1
(43) Pub. Date: Dec. 11, 2003

(54) Circuit design duplication system

(76) Inventors: S. Brandon Keller, Evans, CO (US); Gregory Dennis Rogers, Fort Collins, CO (US); Charles Anthony Lelm, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/167,081

(22) Filed: Jun. 10, 2002

(51) Int. Cl. G06F 7/00

(52) U.S. Cl. 707/1

(57) ABSTRACT

Techniques are disclosed for copying a subset of the block design information contained in a circuit design database into a block design “cubby.” A circuit design duplication tool may be implemented in software to copy the block design information. The duplication tool need not be hard-coded with information about the location of block design information for particular blocks within the circuit design database or with information about the logical structure of the database. Rather, circuit design meta-data which indicates the locations of block design information and the logical structure of the database may be provided to the duplication tool to enable the duplication tool to copy the subset of the block design information. The circuit design database and/or the cubby may be stored in a conventional computer file system, and the duplication tool may copy the subset of the block design information using conventional file system commands.

### BACKGROUND

1. Field of the Invention

The present invention relates to integrated circuit design and, more particularly, to techniques for duplicating subsets of integrated circuit designs.

2. Related Art

Integrated circuits (ICs) are becoming increasingly large and complex, typically including millions of individual circuit elements such as transistors and logic gates. Very Large Scale Integrated (VLSI) Circuits are too large and complex for a circuit designer, or even a large team of circuit designers, to manage effectively on an element-by-element basis. As a result of this increased size and complexity, IC designers are increasingly using electronic design automation (EDA) software tools to assist with IC design. Such tools help to manage the complexity of the design task in a variety of ways, such as by allowing ICs to be designed hierarchically, thereby enabling the design to be divided into modules and enabling the design task to be divided among multiple designers in a manner that limits the complexity faced by any one designer.

Various hardware description languages (HDLs) have been developed which allow circuit designs to be described at various levels of abstraction. A description of a circuit according to an HDL (referred to herein as an “HDL model” of the circuit) may, for example, describe a particular circuit design in terms of the layout of its transistors and interconnects on an IC, or in terms of the logic gates in a digital system. Descriptions of a circuit at different levels of abstraction may be used for different purposes at various stages in the design process. HDL models may be used for testing circuits and circuit designs, as well as for fabricating the circuits themselves. The two most widely-used HDLs are Verilog and VHDL (Very High Speed Integrated Circuits (VHSIC) Hardware Description Language), both of which have been adopted as standards by the Institute of Electrical and Electronics Engineers (IEEE). VHDL became IEEE Standard 1076 in 1987 and Verilog became IEEE Standard 1364 in 1995.

EDA tools typically allow circuit designers to specify circuit designs using HDLs. Such tools may, for example, accept an HDL description of a circuit as an input and create, from the description, a hierarchical database representing the circuit design. The EDA tool may also display a graphical representation of the circuit design based on the HDL description. One example of such a tool for designing VLSI circuits is Virtuoso® Schematic Composer, available from Cadence Design Systems, Inc. of San Jose, Calif.

EDA tools may also allow the circuit designer to design circuits using a graphical user interface. The EDA tool may, for example, display a graphical 2D or 3D representation of the circuit design, in the form of a schematic diagram, on a display monitor. The circuit designer may use conventional input devices, such as a mouse and/or keyboard, to edit the design through the EDA tool's graphical user interface.

As mentioned above, modern complex circuit designs typically have a hierarchical structure which is used to control the complexity of the design task. For example, referring to FIG. 1, the logical structure of a conventional hierarchical circuit design database 100 is illustrated in block diagram form. At the top of the hierarchy are a relatively small number of interconnected blocks (or “cells”). Two high-level blocks 102a-b are shown in FIG. 1; a typical circuit design may, however, include hundreds or thousands of such blocks. The number of high-level blocks is, however, significantly smaller than the total number of circuit elements in the corresponding circuit.

In FIG. 1, the names that are used to identify blocks within the database 100 are indicated using names written in all capital letters. For example, the name of block 102a is “HIGH1” and the name of block 104a is “MID1”.

The high-level blocks 102a-b correspond to high-level structural elements of the corresponding circuit. Each of the high-level blocks 102a-b contains information descriptive of properties (such as shape, size, material, and location) of corresponding high-level structural elements in the circuit. The database 100 also contains information descriptive of any connections (e.g., pin connections) between the high-level blocks 102a-b. Information that the database 100 contains about a block is referred to herein as “block design information.”

The circuit designer may use an EDA tool to add, remove, and modify such high-level blocks 102a-b within the circuit design. The EDA tool may, for example, provide a graphical display representing the physical locations of the high-level blocks 102a-b within the circuit design and the interconnections between them. This graphical representation of the physical layout of the circuit design (in contrast to the logical representation of the circuit design hierarchy illustrated in FIG. 1) may be used to perform high-level layout and routing in the circuit design.

As further illustrated in FIG. 1, the high-level blocks 102a-b are composed of mid-level blocks 104a-d, which are in turn composed of low-level blocks 106a-i. The low-level blocks 106a-i may, for example, represent discrete structural circuit elements, such as resistors or logic gates. Although the circuit design database 100 contains three levels of abstraction referred to as “high,” “middle,” and “low,” an actual circuit design database may be arranged in a hierarchy having any number of levels.

When the circuit designer places and lays out the high-level blocks 102a-b within the circuit design using the EDA tool as described above, the EDA tool may not display the mid-level blocks 104a-d or the low-level blocks 106a-i to the circuit designer. In this way, the circuit designer may perform high-level design of the circuit (i.e., by placing and interconnecting high-level blocks 102a-b), without the need to be concerned with lower-level blocks in the design. More generally, when editing a particular level of the circuit hierarchy, the EDA tool does not expose to the circuit designer blocks at lower levels of the hierarchy. In this way, the circuit's hierarchical design enables the complexity faced by the circuit designer to be reduced to a manageable level.

It is common for different circuit designers or teams of circuit designers to design cells at different levels of the circuit hierarchy. One circuit design team, for example, may be tasked with designing the high-level blocks 102a-b, another design team with designing the mid-level blocks 104a-d, and a third design team with designing the low-level cells 106a-i. Similarly, a particular circuit designer or design team may be assigned to work on a particular cell or cells in one level in the hierarchy.

Typically, such various teams of circuit designers engage in design contemporaneously. To maintain the integrity of the circuit design database 100, however, it is necessary to prevent modifications made by one circuit designer to a block at a particular level of the design hierarchy from immediately propagating to blocks at higher levels of the design hierarchy. If, for example, all circuit designers were to work on different levels of the circuit design database 100 directly and contemporaneously, changes made to one level of the design hierarchy (e.g., to the mid-level blocks 104a-d) would affect the structure of blocks (e.g., high-level blocks 102a-b) at higher levels of the design hierarchy. Such changes would interfere with the work being performed by circuit designers on the higher levels of the design hierarchy. Furthermore, information in the circuit design database 100 could become corrupted or otherwise internally inconsistent as the result of multiple changes made by different circuit designers on different overlapping portions of the database 100.

To alleviate such problems, conventional EDA tools provide mechanisms to make copies of design data in local work areas. When a circuit designer wishes to modify a particular block in the circuit design database 100, the circuit designer instructs the EDA tool to copy that block of the circuit design database 100, and all blocks below it in the hierarchy, into a virtual “cubby.” The cubby is, in essence, a snapshot of the state of a block and all of the blocks it contains at a particular point in time. The cubby is implemented as a data structure that may, for example, reside on the circuit designer's local hard disk drive. A cubby may contain snapshots of more than one block in the circuit design database 100.

Having copied a particular block and its descendants into a cubby, the circuit designer may use the EDA tool to modify the copy of the block design that resides in the cubby (referred to herein as the “cubbied block design”), rather than the original (“live”) version of the block design that resides in the circuit design database 100 itself. Changes made by the circuit designer to the cubbied block design do not change the original block design in the circuit design database 100, and therefore do not interfere with the work being performed by other circuit designers on higher-level block designs which include the cubbied block design. Once the circuit designer is finished modifying the cubbied block design, he may instruct the EDA tool to copy the modified cubbied block design from the cubby back into the circuit design database 100, thereby replacing the original version of the block design. The changes made by the circuit designer to the block design thereby become available to other circuit designers. Copying of multiple modified cubbied block designs back into the circuit design database 100 may be scheduled and synchronized to maintain the integrity of the database 100.

Designing a cubbying software tool can be a difficult and tedious task. For example, using conventional techniques, copying subsets of the circuit design database 100 into cubbies requires knowledge of the particular features of the data structures and file format in which the database 100 is stored. More specifically, it may be necessary for the cubbying software tool to be hard-coded with knowledge of: (1) the particular hierarchical structure of the circuit design database; (2) the locations at which block information is stored in the database; (3) the data structures used by the database 100 to represent block information, and (4) the particular binary file format in which the database 100 is stored on disk. Changes to any of these features of the database 100 may require the cubbying tool to be recoded.

What is needed, therefore, are improved techniques for duplicating integrated circuit designs and subsets thereof.

### SUMMARY

Techniques are disclosed for copying a subset of the block design information contained in a circuit design database into a block design “cubby.” A circuit design duplication tool may be implemented in software to copy the block design information. The duplication tool need not be hard-coded with information about the location of block design information for particular blocks within the circuit design database or with information about the logical structure of the database. Rather, circuit design meta-data which indicates the locations of block design information and the logical structure of the database may be provided to the duplication tool to enable the duplication tool to copy the subset of the block design information. The circuit design database and/or the cubby may be stored in a conventional computer file system, and the duplication tool may copy the subset of the block design information using conventional file system commands.

For example, in one aspect a computer-implemented method is provided for use in a system including a circuit design database tangibly stored on a first computer-readable medium. The circuit design database contains block design information descriptive of a plurality of blocks in a circuit design. The method includes steps of: (A) obtaining an identifier of one of the plurality of blocks; (B) identifying a subset of the block design information that corresponds to the identified block based on first meta-data that maps a plurality of block identifiers to a plurality of locations of subsets of the block design information; and (C) copying the identified subset of the circuit design database to a second computer-readable medium, such as a directory in a computer file system.

The identifier may, for example, be a name of the identified block within the circuit design database. The identifier may, for example, be a name of a file in a computer file system in which block design information for the identified block is stored. The step (B) may include a step of identifying the file based on the file name, and the step (C) may include a step of copying the file to the second computer-readable medium.

The identifier may, for example, be a name of a directory in a computer file system in which block design information for the identified block is stored. The step (B) may include a step of identifying the directory based on the directory name, and the step (C) may include a step of copying at least one file in the directory to the second computer-readable medium. The plurality of blocks may be arranged hierarchically in the circuit design, and the step (C) may further include steps of: identifying at least one child of the identified block, and performing the steps (A), (B), and (C) for the at least one child.

The plurality of blocks may be arranged hierarchically in the circuit design. The step (C) may further include steps of: (C)(1) identifying at least one child of the identified block; and (C)(2) performing the steps (A), (B), and (C) for the at least one child. The step (C)(1) may include a step of identifying the at least one child of the identified block based on second meta-data that maps the plurality of block identifiers to child blocks of the plurality of blocks. The step (C)(1) may include a step of identifying at least one subdirectory in a computer file system directory corresponding to the identified block.

Other features and advantages of various aspects and embodiments of the present invention will become apparent from the following description and from the claims.

### BRIEF DESCRIPTION OF THE DRAWINGS

FIG. 1 is a block diagram of the logical structure of a prior art circuit design database;

FIG. 2A is a functional block diagram of a system for duplicating a subset of a circuit design according to one embodiment of the present invention;

FIG. 2B is a block diagram of the logical structure of circuit design meta-data according to one embodiment of the present invention;

FIG. 2C is a block diagram of the logical structure of a circuit block name-to-location mapping according to one embodiment of the present invention;

FIG. 2D is a block diagram of the logical structure of a circuit block parent-to-child mapping according to one embodiment of the present invention;

FIG. 3 is a functional block diagram of a system for editing a duplicated subset of a hierarchical circuit design according to one embodiment of the present invention;

FIG. 4 is a block diagram of the logical structure of a hierarchically-arranged collection of block design information directories according to one embodiment of the present invention;

FIG. 5 is a flow chart of a method that is performed by a circuit design duplication tool to copy block design information from a circuit design database to a block design cubby according to one embodiment of the present invention; and

FIG. 6 is a block diagram of the logical structure of a block design cubby according to one embodiment of the present invention.

### DETAILED DESCRIPTION

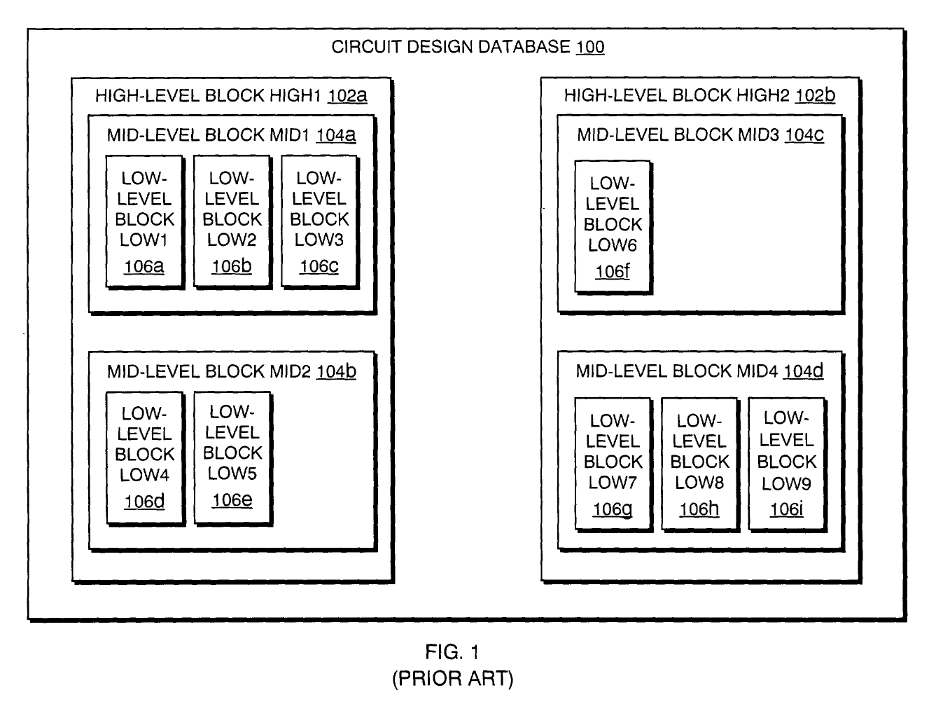

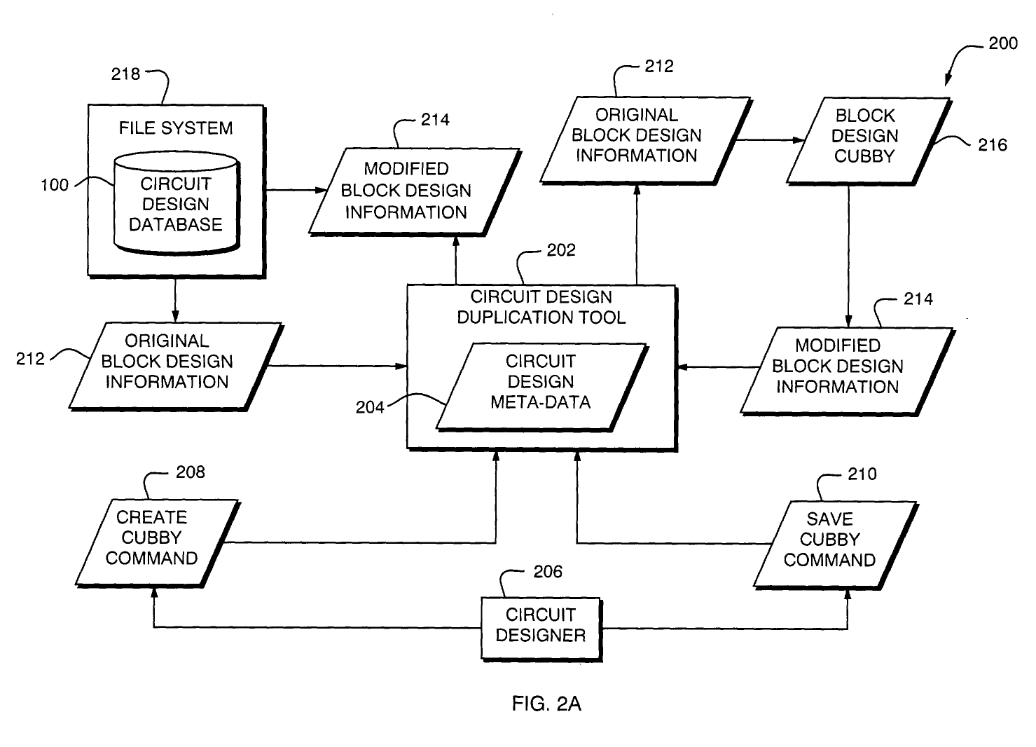

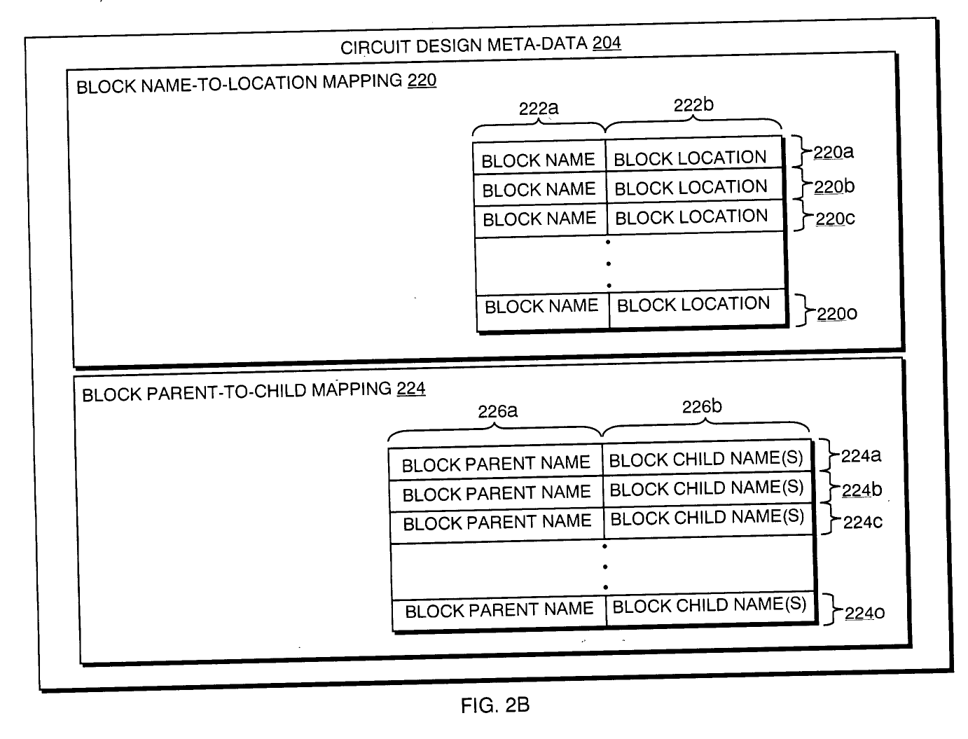

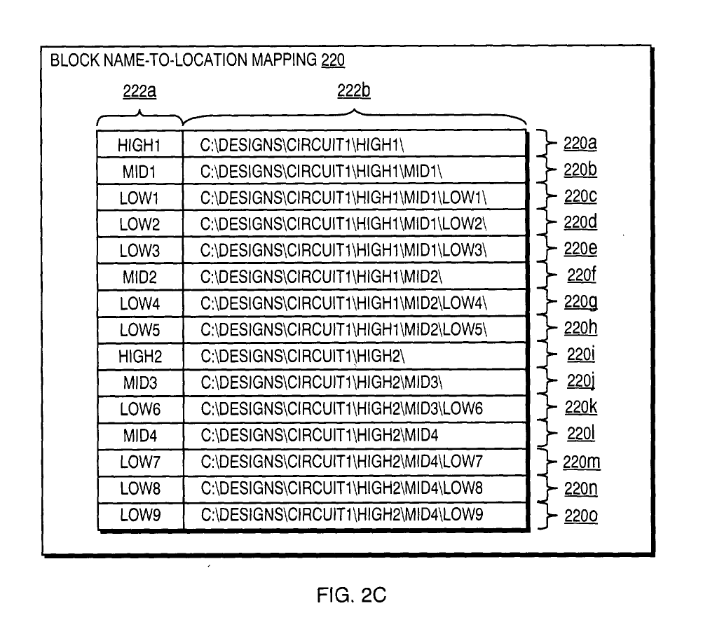

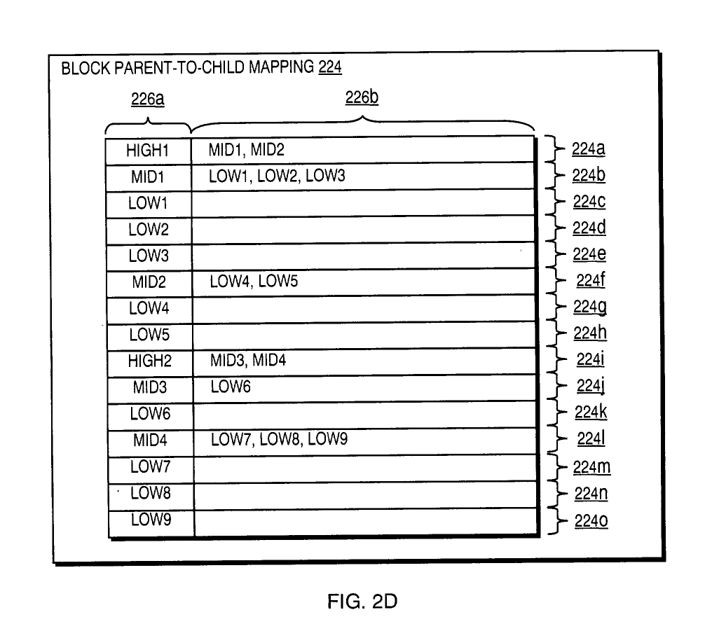

Referring to FIG. 2A, a functional block diagram is shown of a system 200 for duplicating a subset of a circuit design (such as a VLSI design) according to one embodiment of the present invention. The circuit design may, for example, be embodied in conventional circuit design database 100, described in more detail above with respect to FIG. 1. Some or all of the circuit design database 100 may be stored in a computer file system 218, such as the Microsoft Windows® NT File System (NTFS) or a Unix-based file system.

The circuit design database 100 may contain various kinds of block design information for each block in the design. The block design information for a particular block may include, for example, a schematic view of the block, a layout view of the block, and the results of a design rule check (DRC) or other analysis performed on the block's design. Block design information for a particular block may, for example, be stored in a particular directory in the file system 218, and each kind of block design information for the block may be stored in a distinct subdirectory of that directory.

The system 200 includes a circuit design duplication tool 202 which may copy the circuit design database 100, or any subset thereof, into a block design cubby 216. The circuit design duplication tool 202 may, for example, be implemented as a computer program. The block design cubby 216 may, for example, be stored in a directory in the same file system 218 as the circuit design database 100 or in a different file system. A human circuit designer 206 may, for example, provide a create cubby command 208 to the circuit design duplication tool 202. The create cubby command 208 may specify a subset of the circuit design database 100 to be copied into the block design cubby 216. For example, assume that the “create cubby” command 208 indicates that mid-level block 104a is to be copied into the block design cubby 216. The circuit design duplication tool 202 may copy from the circuit design database 100 into the block design cubby 216 some or all of the block design information for block 104a and the blocks that it contains. The information copied thereby is referred to herein as original block design information 212.

Alternatively, the create cubby command 208 may instruct the circuit design duplication tool 202 to update any block design information in the block design cubby 216 with any newer block design information contained in the circuit design database 100. Upon receiving the create cubby command 208, the circuit design duplication tool 202 may replace block design information in the block design cubby 216 with corresponding newer block design information in the circuit design database 100, if any.

The circuit design duplication tool 202 may copy block design information from the database 100 into the block design cubby 216 without being hard-coded with knowledge of one or more of the following: (1) the particular hierarchical structure of the circuit design database 100; (2) the locations at which block information is stored in the database 100; (3) the data structures used by the database 100 to represent block information, and (4) the particular binary file format in which the database 100 is stored on disk. These four features of the database 100, in any combination, are referred to herein as the “format” of the database 100.

For example, circuit design meta-data 204 may include information descriptive of the block design information contained in the circuit design database 100 in a manner that is independent of the data format of the database 100. The circuit design meta-data 204 may, for example, be implemented as a command line or as a file in the file system 218, and be provided as an input to the circuit design duplication tool, thereby enabling the circuit design duplication tool 202 to copy block design information from the circuit design database 100.

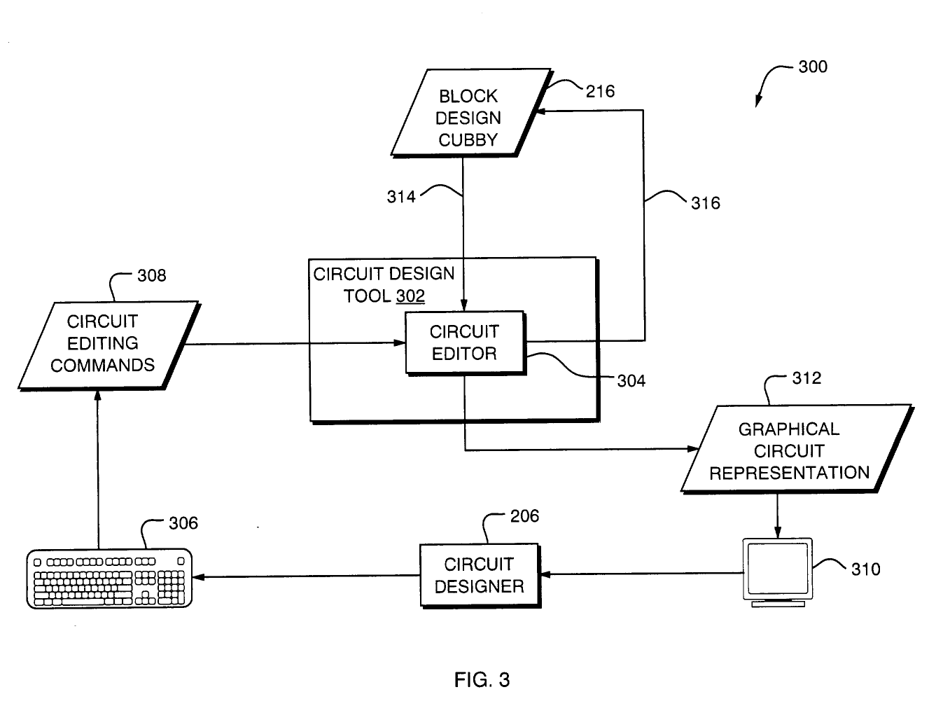

Referring to FIG. 3, once the specified subset of the circuit design database is copied into the block design cubby 216, the circuit designer 206 may edit the block design cubby 216 using a conventional circuit editor 304 provided by a conventional circuit design tool 302. For example, the circuit designer 206 may issue circuit editing commands 308 to the circuit editor 304 using a keyboard 306 or other input device. In response to receipt of the editing commands 308, the circuit editor 304 may modify 316 the block design information in the block design information cubby 216. The circuit editor 304 may also extract 314 information from the block design cubby 216 to display a graphical representation 312 of the block design being edited on a display monitor 310 or other output device.

When the circuit designer 206 is finished modifying the block design contained in the block design cubby 216, the circuit designer 206 may issue a save cubby command 210 to the circuit design duplication tool 202, in response to which the circuit design duplication tool 202 may copy the modified block design information 214 contained in the block design cubby 216 back into the circuit design database 100, replacing the original block design information 214 contained therein. The circuit design duplication tool 202 may copy the modified block design information 214 into the circuit design database 100 using the same file copying techniques that are used to copy the original block design information 212 into the block design cubby 216. The system 200 therefore provides the advantages of cubbying without requiring the circuit design duplication tool 202 to be hard-coded with knowledge of the format of the database 100.

Other operations may be performed on the block design information stored in the cubby 216. For example, it is often desirable to use Electronic Computer Aided Design (E-CAD) tools to run analyses on block design information in the circuit design database 100. Examples of such tools include VoltageStorm™ SoC, available from Simplex Solutions, Inc., of Sunnyvale, Calif., and PathMill®, available from Synopsys, Inc., of Mountain View, Calif. It is typically preferable for such tools to operate on block design information stored in the cubby 216 rather than on the circuit design database itself 100, since it is preferable to analyze an unchanging design ‘snapshot.’ Although some of the description herein may refer to the process of copying a subset of the circuit design database 100 into the cubby 216, the circuit design duplication tool 202 may copy all of the block design information in the circuit design database 100 into the cubby 216 for use by E-CAD tools or for other purposes. Therefore, as used herein the term “subset” may refer to all or any portion of the circuit design database 100.

Having described the general operation of the circuit design duplication system 200 illustrated in FIG. 2A, particular embodiments of the system 200 will be described in more detail.

Referring to FIG. 2B, one embodiment of the circuit design meta-data 204 is illustrated in block diagram form. The circuit design meta-data 204 includes both a block name-to-location mapping 220 and a block parent-to-child mapping 224. As described in more detail below, in other embodiments the circuit design meta-data 204 may include only one of the mappings 220 and 224, or neither of the mappings 220 and 224.

Block design information in the circuit design database 100 may be distributed across a large number and variety of directories and files in the file system 218. The distribution of block design information throughout the file system 218 may or may not correspond to the hierarchical internal structure of the circuit design database 100 (FIG. 1). The block name-to-location mapping 220 maps names of blocks in the circuit design database 100 to locations in which block design information for such blocks is stored. Block name-to-location mapping 220 includes two columns 222a and 222b. Block name column 222a specifies the name of a block, and block location column 222b specifies a location at which the block design information for the corresponding block is stored. Block name-to-location mapping 220 includes individual mappings 220a-o, each of which corresponds to a particular one of the blocks in the circuit design database 100. Although the particular block-name-to-location mapping 220 illustrated in FIG. 2B includes fifteen mappings (one for each of the blocks in the circuit design database 100 illustrated in FIG. 1), there may be any number of individual mappings in the block name-to-location mapping 220.

Furthermore, there may be more than one individual name-to-location mapping for each block if, for example, block design information for a particular block is stored in more than one location. The block locations 222b may, for example, be directory names, file names, or both. Furthermore, the block name-to-location mapping 220 may be implemented using data structures and/or methods other than a table, as will be appreciated by those of ordinary skill in the art.

The block name-to-location mapping 220 may map the name of a particular block to the locations of: (1) all of the block design information for the block, or (2) a subset of the block design information for the block. For example, as described above, the circuit design database 100 may include multiple kinds of block design information for a particular block. The block name-to-location mapping 220 may, for example, map the name of a block to the schematic design information for the block but not to other kinds of block design information for the block. In this way, the block name-to-location mapping 220 may be used not only to specify locations of block design information for blocks in the circuit design database 100 but to specify which block design information to copy into the block design cubby 216 for particular blocks in the circuit design database 100.

Furthermore, the circuit design meta-data 204 may, for example, specify the locations of schematics for blocks in the database 100, while another set of circuit design meta-data (not shown) may specify the locations of block design information needed for use by a particular design analysis tool. If, for example, the two sets of circuit design meta-data are stored in different files, the circuit designer 206 may specify which information (e.g., schematics or analysis tool information) is to be copied into the block design cubby 216 by providing the corresponding circuit design meta-data file as input to the circuit design duplication tool 202. Embodying the name-to-location mapping 220 in the circuit design meta-data 204 thereby de-couples the mapping 220 from the circuit design duplication tool 202 itself. Because no particular mapping is hard-coded into the circuit design duplication tool 202, the circuit designer 206 has more flexibility to copy different kinds and subsets of block design information into the block design cubby 216 merely by providing different sets of circuit design meta-data to the circuit design duplication tool 202.

Referring to FIG. 2C, an example of the block name-to-location mapping 220 is shown which corresponds to the circuit design database 100 illustrated in FIG. 1. Consider, for example, individual mapping 220a, which corresponds to high-level block 102a. Individual mapping 220a indicates that block design information for a block (i.e., block 102a) named “HIGH1” (column 222a) is stored in a directory having a path name of “C:\DESIGNS\CIRCUIT1\HIGH1\” (column 222b). Now consider individual mapping 220b, which corresponds to mid-level block 104a (named “MID1”). Individual mapping 220b indicates that block design information for a block (i.e., block 104a) named “MID1” (column 222a) is stored in a directory having a path name of “C:\DESIGNS\CIRCUIT1\HIGH1\MID1\” (column 222b). The meaning of the remaining individual mappings 220c-0 should be clear based on the description just provided.

Referring again to FIG. 2B, the block parent-to-child mapping 224 maps names of parent blocks in the circuit design database 100 to the names of their children. As used herein, the terms “parent,” “child,” “ancestor,” and “descendant” have their typical meanings with respect to elements of a hierarchical structure. Block parent-to-child mapping 224 includes two columns 226a and 226b. Block parent name column 226a specifies the name of a block, while block child name column 226b specifies the name(s) of the block's children, if any. Block parent-to-child mapping 224 includes individual mappings 224a-o, each of which corresponds to a particular one of the blocks in the circuit design database 100. Although the particular block-name-to-location mapping 224 illustrated in FIG. 2B includes fifteen mappings (one for each of the blocks in the circuit design database 100 illustrated in FIG. 1), there may be any number of individual mappings in the block parent-to-child mapping 224. Furthermore, the block name-to-location mapping 224 may be implemented using data structures and/or methods other than a table, as will be appreciated by those of ordinary skill in the art.

Referring to FIG. 2D, an example of block parent-to-child mapping 224 corresponding to the circuit design database illustrated in FIG. 1 is shown. Consider, for example, individual mapping 224a, which indicates that block design information for a block (i.e., block 102a) named “HIGH1” (column 226a) has two children named “MID1” and “MID2” (column 226b). Now consider individual mapping 224b, which indicates that block design information for a block (i.e., block 104a) named “MIDI” (column 226a) has three children named “LOW1,” “LOW2,” and “LOW3” (column 226b). If column 226b is empty for a particular individual mapping, the corresponding block has no children (as in the case of block 106a (“LOW1”), corresponding to individual mapping 224c). The meaning of the remaining individual mappings 224c-0 should be clear based on the description just provided.

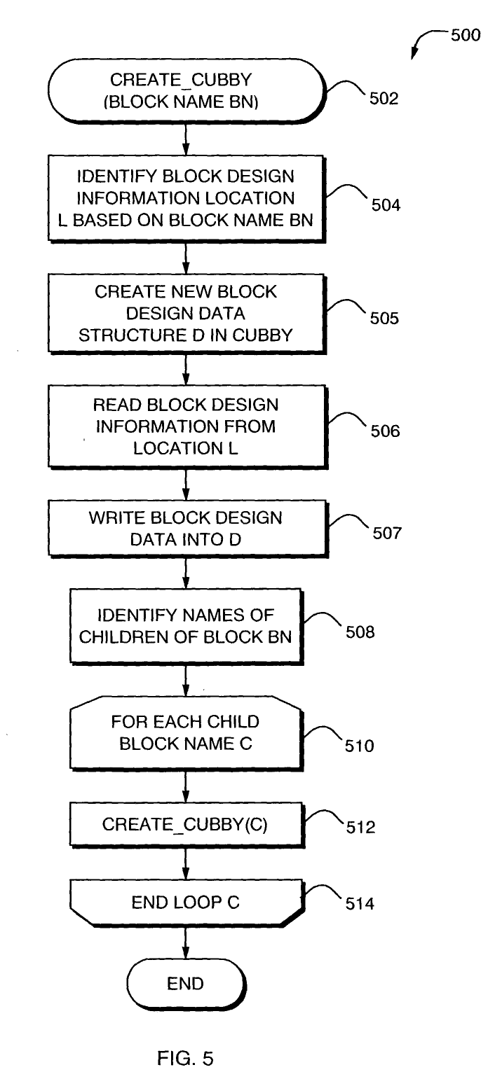

Referring to FIG. 5, a flowchart of a method 500 is shown that is performed by the circuit design duplication tool 202 to copy a subset of the circuit design database 100 to the block design cubby 216 according to one embodiment of the present invention. The method 500 may be implemented as a software routine named Create_Cubby( ) which takes a single parameter BN as input (step 502). The parameter BN specifies the block name of a block B for which block design information is to be copied into the block design cubby 216.

The method 500 identifies the location L of the block design information for block B based on the block name BN (step 504). The location L may, for example, be one or more directories and/or files in a computer file system. The location L may, however, be any computer-readable location. For example, the location L may be a single file in a computer file system, a portion of a file (such as a record in a database, text in a text file, or one or more rows in a spreadsheet table), or a data structure (such as a list or array) in a computer program.

The method 500 may, for example, use the block name-to-location mapping 220 to perform step 504. The method 500 may, for example, search the individual block-to-location mappings 220a-o for a mapping (or mappings) in which the value in the block name column 222a is equal to the block name BN, and identify the location L as the corresponding value(s) in the block location column 222b.

One advantage of providing the block name-to-location mapping 220 in the circuit design meta-data 204 and thereby loosening the coupling between the block name-to-location mapping 220 from the circuit design duplication tool 202 is that changes in the organization of block design information in the circuit design database 100 need not require the design of the circuit design duplication tool 202 to be modified (e.g., re-coded). Rather, the change in block design information organization may simply be reflected by a corresponding change to the block name-to-location mapping 220. Such a change will typically be easier and less time-consuming to perform than a change to the design of the circuit design duplication tool 202 itself.

The method 500 creates a new block design data structure D in the block design cubby 216 (step 505), reads the original block design information 212 from location L (step 506), and writes the original block design information 212 into the data structure D in the block design cubby 216 (step 507). The method 500 may copy the original block design information 212 in steps 505-507 using any of a variety of techniques. If, for example, the circuit design database 100 and the block design cubby 216 are stored in the file system 218, steps 505-507 may be performed using well-known and conventional computer commands for writing and reading information to and from the file system 218. This is not, however, a limitation of the present invention. Rather, any appropriate techniques may be used to copy the original block design information 212 into the cubby 216. For example, if the original block design information 212 is stored in a data structure in memory, step 506 may be implemented using commands implemented in a computer programming language such as C or Java for copying information from one data structure to another.

If the cubby 216 already contains block design information for block BN prior to the initiation of step 507, the method 500 in step 507 may either replace the existing block information in the cubby 216 with the new block design information 212, signal an error to the circuit designer 206, or prompt the circuit designer 206 to choose whether to replace the existing block design information or terminate the process 500.

The method 500 identifies the names of any children of the block BN (step 508). The method 500 may, for example, use the block parent-to-child mapping 224 to perform step 508. The method 500 may, for example, search the individual parent-to-child mappings 224a-o for a mapping (or mappings) in which the value in the block parent name column 226a is equal to the block name BN, and identify the names of the block's children as the names contained within the block child name column 226b of the mapping corresponding to parent block name BN.

For each child block name C (step 510), the method 500 calls the Create_Cubby( ) method 500 with the name C as a parameter (step 512). In other words, the method 500 recursively calls itself to copy the block design information for all of the descendants of block B. Upon termination of the loop (step 514), method 500 terminates.

The method 500 may perform steps 502-514 in any of a variety of ways. For example, some or all of the steps in method 500 may be performed by calling procedures in an Application Program Interface (API) provided by the circuit design tool 302 (FIG. 3) for accessing the circuit design database 100. For example, the block parent-to-child mapping 224 may be implemented in the form of a file or other data structure for each block in the circuit design database 100 which specifies the children of the block. The file may be stored in the same directory as the block's design information. The circuit design duplication tool 202 may perform step 508, for example, by directly reading information from the file or by making an API call which reads information from the file. In such embodiments, the circuit design duplication tool 202 need not maintain the distinct block parent-to-child mapping 224 illustrated in FIG. 2B.

Alternatively, some or all of the steps in method 500 may be performed using computer program instructions for directly accessing the circuit design database 100 and/or the block design cubby 216. As described in more detail below, some or all of the steps in method 500 may be performed using API procedures provided by the file system 218. Those of ordinary skill in the art will appreciate how to apply these various techniques in different combinations to implement method 500.

Some or all of the circuit design meta-data 204 may, for example, be implemented in the file system 218 rather than being provided as a distinct data structure as illustrated in FIG. 2A. For example, the block name-to-location mapping 220, the block parent-to-child mapping 224, or both may be implemented in the file system 218. One embodiment in which the block name-to-location mapping 218 is implemented in the file system 218 will now be described.

Block design information for each block in the circuit design database 100 may be stored in a distinct directory in the file system 218. For example, block design information for high-level block 102a may be stored in a single directory which only contains block design information for block 102a. Furthermore, block design information for a particular block may be stored in a directory having the same name as the block itself (i.e., the name that is used to identify the block within the circuit design database 100). For example, the directory that stores block design information for block 102a (“HIGH1”) may be named “HIGH1” and the directory that stores block design information for the block 104a (“MID1”) may be named “MID1”.

Referring again to FIG. 5, the block name BN may therefore refer to the name both of a block and to the name of the directory in which block design information for the block is stored. The Create_Cubby( ) method 500 may have additional parameters. For example, a parameter I_{P} may specify the path name(s) of one or more directories in which block design information may be found (i.e., the path name(s) of one or more directories in which the circuit design database 100 is stored). A parameter D_{P} may specify a path name of the destination directory that is to be used to store the block design cubby 216. Although the block name BN may refer to more than one block, in the particular examples described herein BN refers to a single block for ease of explanation.

The block location L (FIG. 5) may be a block source path name or file name (referred to herein as S), which identifies the path or file from which block design information is to be copied. The method 500 may identify the block source name S based on block name BN (FIG. 5, step 504) by, for example, searching the block design information path(s) I_{P} and subdirectories thereof for a file/directory having the name S.

The method 500 may create a new block design data structure D in the block design cubby 216 (FIG. 5, step 505) by creating a new file or directory in the destination directory D. If the source name S specifies a single file, the method 500 may read original block design information 212 from the source S (FIG. 5, step 506) by reading the file. If the source name S specifies a directory, the method 500 may read original block design information 212 from the source S reading all of the files in the directory. The method 500 may write the original block design information 212 into the destination directory D by writing the file(s) read in step 506 into the directory D. Steps 505-507 may be performed using conventional commands for creating, reading, and writing directories and files in a file system.

The method 500 may therefore copy the original block design information 212 from the circuit design database 100 into the block design cubby 216 without requiring knowledge of the particular data format in which the circuit design database 100 is stored. Although the circuit design duplication tool 202 copies information 212 from the circuit design database 100 using method 500, the copy operation does not require examining or processing any of the database's contents. Rather, the method 500 may use conventional file read and write commands, of the kind that are provided by conventional operating systems and programming languages, to copy the original block design information 212 from the circuit design database 100 to the block design cubby 216.

Furthermore, using conventional file system commands to perform block name-to-location mapping (FIG. 5, step 504) enables such mapping to be performed without implementing the block name-to-location mapping 220 as a separate data structure as illustrated in FIG. 2B. Moreover, the techniques described above enable block locations to be identified for specified blocks even when the names and locations of block design information changes, because the naming scheme described above allows conventional file system commands to be used to map block names to corresponding block design information, regardless of the names of blocks or the particular organization of blocks within the design hierarchy. This feature provides an advantage over conventional cubbying tools, which typically require re-coding each time the organization of the circuit design database 100 changes.

As described above, the circuit design duplication tool 202 may map the name of a block to the name(s), if any, of its children (FIG. 5; step 508; FIG. 5B, step 534). Although, as described above with respect to FIG. 5, the circuit design duplication tool 202 may perform this mapping using the parent-to-child mapping 224 (FIG. 2D), the mapping of parent to child blocks may be implemented in the file system 218 itself, obviating the need for the separate parent-to-child mapping 224.

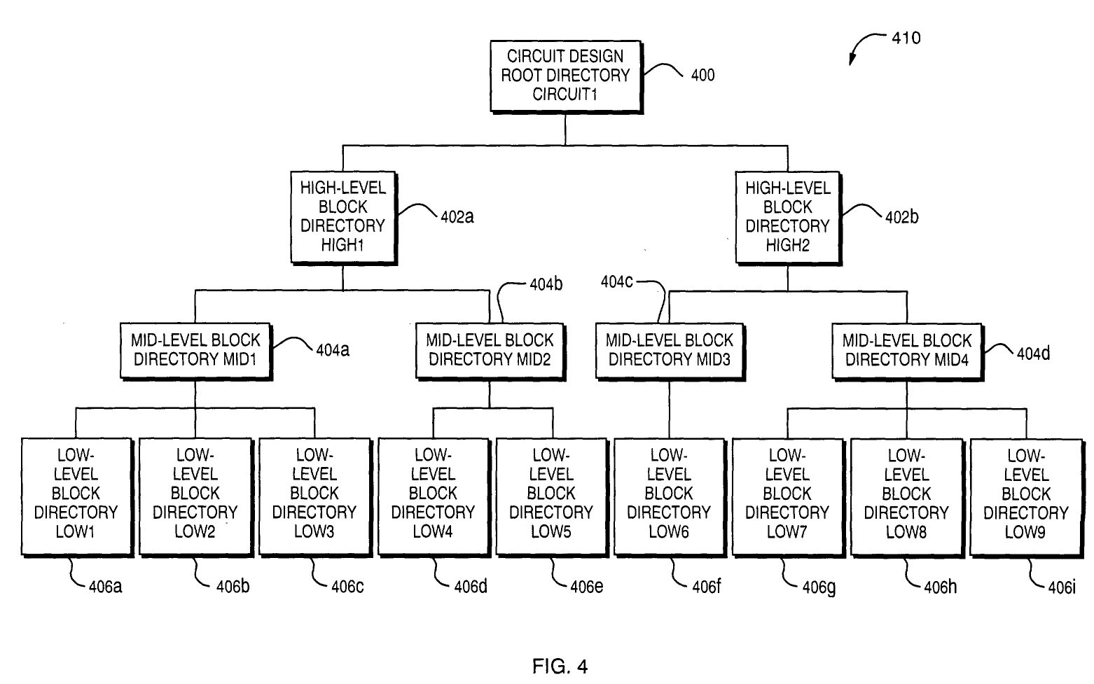

For example, referring to FIG. 4, in one embodiment block design information in the circuit design database 100 is stored in a circuit design root directory 400 in computer file system 218. For purposes of example the name of the circuit design root directory 400 is “CIRCUIT1.” The circuit design root directory 400, and its sub-directories, may have the same hierarchical structure as that of the circuit design database 100 itself (illustrated in FIG. 1). For example, the circuit design root directory 400 may correspond to the root of the circuit design database 100. The circuit design root directory 400 includes high-level block directories 402a-b. High-level block directory 402a corresponds to high-level block 102a and high-level block directory 402b corresponds to high-level block 402b. Similarly, mid-level block directories 404a-d correspond to mid-level blocks 104a-d, respectively, while low-level block directories 406a-d correspond to low-level blocks 106a-i, respectively. Directories 400, 402a-b, 404a-d, and 406a-i form a file system hierarchy 410. Each directory in the hierarchy 410 includes files containing block design information for the corresponding block(s).

Block design information in the circuit design database 100 may be organized into an appropriate hierarchical structure in any of a variety of ways. For example, conventional EDA tools allow the circuit designer 206 to specify the names and locations of block design information files. The circuit designer 206 may therefore save block design information in directories having the same names as blocks themselves and in a hierarchical directory structure such as that shown in FIG. 4.

Assume, for example, that the file system 218 is a Microsoft Windows-based file system, and that the circuit design root directory 400 is a subdirectory of a directory named DESIGNS that is in the root directory of a hard disk drive having drive letter C. In such a case the full path name I_{P} of the circuit design root directory 400 would be “C:\DESIGNS\CIRCUIT1\”. This path name may be passed as a parameter to the Create_Cubby( ) method 500, described above.

If block design information in the database 100 is organized hierarchically in the file system 218 as illustrated in FIG. 1, the method 500 may, for example, map parent block names to child block names (FIG. 5, step 508) by searching block BN's directory for subdirectories. For example, searching the mid-level block directory 404a for subdirectories would identify low-level block directories 406a-c. Techniques for identifying subdirectories of a directory are well-known to those of ordinary skill in the art. Because the hierarchy of the circuit design root directory 400 and its descendants corresponds to the hierarchy of the circuit design database 100 (FIG. 1), identifying subdirectories of the block EN's directory effectively identifies the names of the children of block BN (step 508) without the need to maintain the block parent-to-child mapping 224 as a separate data structures as illustrated in FIG. 2B.

A particular example of the operation of method 500 will now be described to further clarify how the method 500 may be used to copy original block design information 212 into the block design cubby 216. In this embodiment, the block name BN 552 is “MID1”, indicating that block 104a (FIG. 1), whose block design information is stored in directory 404a (FIG. 4), is to be copied into the block design cubby 216 (FIG. 2A).

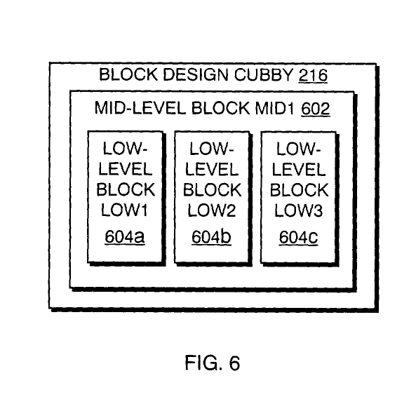

When the circuit designer 206 transmits the create cubby command 208 to the circuit design duplication tool 202, the Create_Cubby( ) method 500 executes (FIG. 5). The method 500 identifies the block design information location L as the mid-level block directory 404a (FIG. 4) using any of the techniques described above (step 504). Referring to FIG. 6, the method 500 creates a new directory 602 in the block design cubby 216 to store block design information for block 104a (FIG. 5, step 505). The method 500 reads block design information 212 for block 104a from the directory 404a (step 506) and writes the information 212 into directory 602 (step 507).

The method 500 identifies the names of the children of block 104a using any of the techniques described above (step 508). The method 500 may, for example, identify the names (“LOW1”, “LOW2”, and “LOW3”) of the sub-directories 406a-c of the directory 404a. The method 500 then calls itself for each of the identified sub-directories (steps 510-514).

In steps 510-514, the method 500 applies the techniques just described to create sub-directories 604a-c (FIG. 6) within directory 602 in the cubby 216, and to copy block design information for the low-level blocks 106a-c from their respective directories 406a-c in the database 100 into their respective directories 604a-c in the cubby 216. If the children of low-level blocks 106a-c had children, the method 500 would be repeated for them, and so on. Upon termination of the method 500, the block design cubby 216 contains a copy of the specified block design information for block 104a and all of its descendants.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

The description herein refers to “copying” block design information (e.g., steps 506-7 of FIG. 5). As used herein, the term “copying” refers to copying the information content of block design information. The format, however, in which block design information 212 is stored in the block design cubby 216 may, however, differ from the format in which the block design information 212 is stored in the circuit design database 100. The circuit design duplication tool 202 may, for example, process block design information 212 in any of a variety of ways (such as by compression or encryption) prior to storing the block design information 212 in the cubby 216. Furthermore, the circuit design duplication tool 202 may, for example, copy less than all of the block design information for a particular block or blocks.

The particular circuit design database 100 is described herein as having a “hierarchical” structure. The present invention, however, is not limited to use with circuit designs having a hierarchical structure. Furthermore, as used herein, the term “hierarchical structure” refers to a structure in which elements (such as circuit block designs) may partially and/or completely contain other elements. The term “hierarchical structure” is not, however, limited to structures (such as the file system hierarchy 410 illustrated in FIG. 4) having a single root node (e.g., the circuit design root directory 400).

The various data structures (e.g., the circuit design database 100, the original block design information 212, the modified block design information 214, the block design cubby 216, the circuit design meta-data 204, the create cubby command 208, and the save cubby command 210) described herein may be implemented in any of a variety of ways. For example, these and other data structures within the scope of the claims may be implementable as files stored in a computer file system (such as database files or text files), command lines, environment variables, or graphical user interface commands. Furthermore, functionality provided by these data structures may be implemented in computer program instructions in the circuit design duplication tool 202.

Elements and components described herein may be further divided into additional components or joined together to form fewer components for performing the same functions.

The techniques described above may be implemented, for example, in hardware, software, firmware, or any combination thereof. The circuit design duplication tool 202 may, for example, be implemented as a computer program. In particular, the method 500 may be implemented as software routines in any of a variety of programming languages, such as the Perl scripting language. The method 500 may be invoked in any of a variety of ways. For example, the method 500 may be a procedure (also referred to as a function or a subroutine) in a computer program that may be invoked by other procedures in the same or other programs using conventional computer program instructions. Alternatively, the method 500 may, for example, be invoked using a textual command line, such as those which are available in variants of the Unix and Microsoft DOS operating systems. The parameters BN, I_{P}, and D_{P} may be command line arguments or environment variables, the values of which may be supplied by the circuit designer 206 using keyboard 306. Alternatively, the method 500 may be invoked using a graphical user interface, such as that provided by the X Window System and the Microsoft Windows line of operating systems. The circuit designer 206 may provide values for the parameters BN, Iₚ, and Dₚ using controls (such as text boxes) provided by such a graphical user interface.

The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. In a system including a circuit design database tangibly stored on a first computer-readable medium, the circuit design database containing block design information descriptive of a plurality of blocks in a circuit design, a computer-implemented method comprising steps of:
(A) obtaining an identifier of one of the plurality of blocks;
(B) identifying a subset of the block design information that corresponds to the identified block based on first meta-data that maps a plurality of block identifiers to a plurality of locations of subsets of the block design information; and
(C) copying the identified subset of the circuit design database to a second computer-readable medium.

2. The method of claim 1, wherein the identifier comprises a name of the identified block within the circuit design database.

3. The method of claim 1, wherein the identifier comprises a name of a file in a computer file system in which block design information for the identified block is stored, wherein the step (B) comprises a step of identifying the file based on the file name, and wherein the step (C) comprises a step of copying the file to the second computer-readable medium.

4. The method of claim 1, wherein the identifier comprises a name of a directory in a computer file system in which block design information for the identified block is stored, wherein the step (B) comprises a step of identifying the directory based on the directory name, and wherein the step (C) comprises a step of copying at least one file in the directory to the second computer-readable medium.

5. The method of claim 4, wherein the plurality of blocks are arranged hierarchically in the circuit design, and wherein the step (C) further comprises steps of:
(C)(1) identifying at least one child of the identified block; and
(C)(2) performing the steps (A), (B), and (C) for the at least one child.

6. The method of claim 1, wherein the first meta-data is tangibly embodied in a third computer-readable medium, and wherein the method further comprises a step of:
(D) prior to the step (B), receiving the first meta-data as an input.

7. The method of claim 1, wherein the plurality of blocks are arranged hierarchically in the circuit design, and wherein the step (C) further comprises steps of:
(C)(1) identifying at least one child of the identified block; and
(C)(2) performing the steps (A), (B), and (C) for the at least one child.

8. The method of claim 7, wherein the step (C)(1) comprises a step of identifying the at least one child of the identified block based on second meta-data that maps the plurality of block identifiers to child blocks of the plurality of blocks.

9. The method of claim 8, wherein the second meta-data is tangibly embodied in a third computer-readable medium, and wherein the method further comprises a step of:
(D) prior to the step (C)(1), receiving the second meta-data as an input.

10. The method of claim 8, wherein the step (C)(1) comprises a step of identifying at least one subdirectory in a computer file system directory corresponding to the identified block.

11. The method of claim 1, wherein the second computer-readable medium comprises a directory in a computer file system.

12. A system comprising:
a circuit design database tangibly stored on a first computer-readable medium, the circuit design database containing block design information descriptive of a plurality of blocks in a circuit design;
means for obtaining an identifier of one of the plurality of blocks;
first meta-data that maps a plurality of block identifiers to a plurality of locations of subsets of the block design information;
means for identifying a subset of the block design information that corresponds to the identified block based on the first meta-data; and
means for copying the identified subset of the circuit design database to a second computer-readable medium.

13. The system of claim 12, wherein the identifier comprises a name of the identified block within the circuit design database.

14. The system of claim 12, wherein the identifier comprises a name of a file in a computer file system in which block design information for the identified block is stored, wherein the means for identifying comprises means for identifying the file based on the file name, and wherein the means for copying comprises means for copying the file to the second computer-readable medium.

15. The system of claim 12, wherein the identifier comprises a name of a directory in a computer file system in which block design information for the identified block is stored, wherein the means for identifying comprises means for identifying the directory based on the directory name, and wherein the means for copying comprises means for copying at least one file in the directory to the second computer-readable medium.

16. The system of claim 15, wherein the plurality of blocks are arranged hierarchically in the circuit design, and wherein the means for copying further comprises:
means for identifying at least one child of the identified block; and
means for applying the means for obtaining, the means for identifying, and the means for copying to the at least one child.

17. The system of claim 12, wherein the first meta-data is tangibly embodied in a third computer-readable medium, and wherein the means for identifying further comprises means for receiving the first meta-data as an input.

18. The system of claim 12, wherein the plurality of blocks are arranged hierarchically in the circuit design, and wherein the means for copying further comprises:
means for identifying at least one child of the identified block; and
means for performing the steps (A), (B), and (C) for the at least one child.

19. The system of claim 18, wherein the system further comprises:
second meta-data that maps the plurality of block identifiers to child blocks of the plurality of blocks; and
wherein the means for identifying the at least one child comprises means for identifying the at least one child of the identified block based on the second meta-data.

20. The system of claim 19, wherein the second meta-data is tangibly embodied in a third computer-readable medium, and wherein the means for identifying the at least one child further comprises means for receiving the second meta-data as an input.

21. The system of claim 19, wherein the means for identifying the at least one child of the identified block comprises means for identifying at least one subdirectory in a computer file system directory corresponding to the identified block.

22. The system of claim 12, wherein the second computer-readable medium comprises a directory in a computer file system.
